(19) United States
(12) Patent Application Publication
(10) Pub. No.: US 2014/0026650 A1
(43) Pub. Date: Jan. 30, 2014

(54) METHOD FOR MONITORING MACHINES WITH ROTATING SHAFTS

(71) Applicant: ALSTOM Technology Ltd, Baden (CH)

(72) Inventors: Maximilian HOBELSBERGER, Wurenlingen (CH); Ken Yves Haffner, Baden (CH); Etienne Louis Laprais, Nussbaumen (CH); Peter Broch, Oberrohrdorf (CH)

(73) Assignee: ALSTOM Technology Ltd, Baden (CH)

(21) Appl. No.: 13/948,748

(22) Filed: Jul. 23, 2013

(30) Foreign Application Priority Data
Jul. 25, 2012 (EP) 12177906.0

(51) Int. Cl. G01M 15/14

(52) U.S. Cl. CPC G01M 15/14
USPC 73/112.02; 73/112.01

(57) ABSTRACT

The invention relates to a method for detecting rubbing and/or contact points on machines with rotating parts. The rotating parts form an electrical coaxial system with respect to the stationary parts of such a machine, in which system electrical voltage pulses are propagated at a characteristic speed because of the small distance between the rotating and the stationary part. Short electrical voltage pulses and/or continuous alternating voltage signals are applied between the rotating part and the stationary part, an electrical connection occurring between the rotating and the stationary part at a rubbing and/or contact point. In order to locate this rubbing and/or contact point as a point of electrical discontinuity, the period of time until the reflected pulses arrive is measured along the path of propagation of the electrical voltage pulses and/or of the continuous alternating voltage signals.

### CROSS-REFERENCE TO RELATED APPLICATIONS

This application claims priority to European Application 12177906.0 filed on Jul. 25, 2012, the contents of which is hereby incorporated in its entirety.

### TECHNICAL FIELD

The invention relates to a method for monitoring machines with shafts that rotate when in operation. The invention also relates to a device for monitoring machines with shafts that rotate when in operation.

This monitoring relates in particular to generators, turbines, and motors when in operation and consists primarily of locating rubbing points of the rotor or the shaft with the housing that occur when there is friction between the shafts. A primary application is the monitoring for this purpose of gas or steam turbines in large power station turbine generator sets.

### BACKGROUND

It is known from the prior art to measure the electrical insulation between a rotor or shaft and the machine housing. When rubbing points occur, this insulation is usually lost because metal-to-metal contact happens at the rubbing point. The insulation can be monitored easily using a test voltage. Monitoring devices of this type are commercially available and widely used.

EP 1 643 259 discloses a method and a device for detecting rubbing or contact points on machines with rotating shafts. This method and this device consist of determining the rubbing or contact points of a shaft when in operation by measuring all the currents that are grounded via a provided end connection of the shaft. Machine shafts are normally grounded in a specific fashion for safety reasons so that the currents that flow away via this grounding device are measured.

A shortcoming of this method is the poor ability to locate the rubbing points. The locating is restricted to establishing whether the rubbing point is situated along the rotor on the driving side of the generator or along the rotor on the non-driving side.

Another method is the EDMS method, as is known from the publication “Smiths Aerospace, GE (1)”, that allows rubbing points in the turbine to be detected. When turbine blades rub against the housing, electrostatically charged clouds of particles occur that can be detected. It is thus possible to locate rubbing points to a certain degree when the row of blades is clearly distinguished by the number of blades and when the rubbing mechanism allows a rubbing pulse frequency to be determined.

It can thus generally be determined that the methods known from the prior art have two important disadvantages:
a) It is a disadvantage here that, in terms of the location of the rubbing point, it is only possible to determine whether it is situated on the driving side or on the non-driving side.
b) It is also disadvantageous that it is not possible to differentiate at friction points between rows of blades with the same number of blades. Moreover, such a system only allows turbines to be monitored and, in contrast, bearings cannot be monitored.

### SUMMARY

The invention will remedy these disadvantages. The object of the invention, as characterized in the claims, is to detect these points of contact between the rotor and the housing during operation, to locate the rubbing points and measure how long they are rubbing. This makes it possible to identify the relevant components and take appropriate measures according to the risk. These measures are, for example, adapting the mode of operation of the machine, in the worst case interrupting operation, or planning in advance for the next stoppage for maintenance. This is based on the recognition that many components are designed such that a certain amount of wear is intentional (grinding of seals), and other components are dimensioned such that rubbing points can be tolerated for a certain short period. There are, however, components that do not tolerate rubbing points.

According to the invention, the method is characterized in that electrical reflectometric measurement is carried out in order to determine the location of the rubbing point. The invention is based on the recognition that the shaft, turbine and generator is an electrical coaxial system: the electrically conductive rotor is surrounded by an electrically conductive housing at a relatively short distance. In such systems, electrical voltage pulses are propagated between the inner conductor, i.e. the rotor, and the outer conductor, i.e. the housing, along the respective surfaces at a characteristic speed of propagation, and reflected pulses occur at points of electrical discontinuity. It has also been noted that an electrically conductive connection between the rotor and the housing occurs at a rubbing point and acts as a point of electrical discontinuity, or that a residual dielectric gap is so narrow that it also acts as a point of discontinuity.

The technical implementation of the invention is characterized in that short electrical voltage pulses are applied at an appropriate point between the rotor and the housing and also that the periods until any reflected pulses arrive are measured by means of passage time measurements. The locations of the rubbing points can be concluded from the periods and a known speed of propagation according to the known laws of reflectometry. The rise and fall time of the pulses is approximately 100 ps, the magnitude of the pulses for example 5V, the duration of the pulses 10 ns and the pulse recovery period 10 μs (pulse rate 100,000/s).

The reflectometric measurement can thus also be carried out as a function of frequency instead of as a function of time. To do this, rather than short pulses, continuous alternating voltage signals, for example sinusoidal ones, can for example be fed into the coaxial system. Voltage and current measurements can be used to determine the transmission characteristics, for example in the form of S parameters, at input ports, for example the impedance, at different frequencies, for example in the range from 1 MHz to 5 GHz. Depending on the location of the rubbing point, rubbing points cause changes in the transmission characteristics and can thus be located.

In summary, it is a feature of the invention to detect rubbing and/or contact points on machines with rotating parts, wherein the latter form an electrical coaxial system with respect to the stationary parts of such a machine, in which system electrical voltage pulses are propagated at a characteristic speed because of the small distance between the rotating and the stationary part. Short electrical voltage pulses and/or continuous alternating voltage signals are preferably applied at an appropriate point between the rotating part and the stationary part. An electrical connection occurs between the rotating and the stationary part at a rubbing and/or contact point. In order to locate this rubbing and/or contact point as a point of electrical discontinuity, passage time measurements are performed along the path of propagation of the electrical voltage pulses and/or of the continuous alternating voltage signals in order to measure the period of time until the reflected pulses arrive.

All the rotating parts of the machine, for example the blades of a gas turbine set, are here preferably carried by a single continuous rotor, the stationary part then being formed by a stator. Any interruptions in the passage of the rotor are thus prevented, which has a positive effect on the accuracy of the measurements.

The rubbing and/or contact points that need to be identified and which can readily cause damage can thus preferably be located using reflectometric measuring methods, which results in continuous monitoring which is easy to implement in existing systems without making any mechanical changes.

The reflective measurement takes place using short electromagnetic pulses fed into the machine, specifically into the cavity between the rotor and the stator, i.e. also preferably into the cavity between the stator blades and rotor blades, when the underlying machine is a gas turbine set.

According to a preferred embodiment, a slowly changing voltage is applied to the rotor with respect to the stator in order to generate the voltage pulses, the amplitude of said voltage being selected to be of such a magnitude that electrical breakdowns between the rotor and stator occur at the rubbing points, and that the electrical breakdowns which occur at the rubbing points are located by passage time measurements and/or on the basis of the pulse patterns forced by the machine geometry.

The voltage pulses and/or continuous alternating voltage signals can be fed in via the grounding contacts of the rotor, which results in simple installation.

Also suitable here is the measure of feeding in the voltage pulses and/or the continuous alternating voltage signals via a bearing on the driving side or non-driving side of a generator belonging to the machine, by virtue of which it is also achieved that there is no need to make any significant changes.

If the turbine belonging to the machine requires to be focussed in a particular fashion with regard to points of discontinuity, this can be achieved by the voltage pulses and/or the continuous alternating voltage signals being fed in at both ends of the turbine. This makes sense when the caloric loads in the turbine are high and accordingly there is also a greater risk that rubbing and/or contact points may occur during operation in association with the operating blades.

The system-inherent capabilities of the method for detecting rubbing and/or contact points that are being formed can thus easily be increased by feeding in the voltage pulses and/or the continuous alternating voltage signals and/or measuring the reflected pulses and/or locating the rubbing and/or contact points via EDMS sensors and/or blade tip distance sensors belonging to the turbine.

According to a supplementary embodiment, the applied, slowly changing voltage is additionally overlaid with rapid voltage pulses, as a result of which the results from such measurements are more meaningful.

Because the safety of the operation of the underlying machine is at stake here, it is advantageous to simultaneously process reference data from a machine with no points of discontinuity for calculating by measurement the rubbing and/or contact points, and/or to simultaneously use reference data from a machine with points of discontinuity that have been located.

In this connection, static methods based on the rotational phases can also be applied to calculate the points of discontinuity, which increases the meaningfulness of the results obtained with them, in terms of obtaining a reliable determination of rubbing and/or contact points that are actually present.

If a pulse coding is to be used to maximize the identification of pulse echoes that are valid for measurement purposes when the pulses are emitted, it is appropriate to provide that a pulse sequence is followed with known, short, identical or different pulse intervals and/or that the pulse amplitudes are gradated appropriately, it also being possible to use radar location methods to detect the pulse echoes, these methods being advantageously applicable within the sense of the invention.

In order to implement the method according to the invention, the machine is designed as a gas turbine set that essentially consists of at least one compressor, at least one combustion chamber, at least one turbine, at least one generator, and at least one rotor, and the rotor is operatively connected to a stator. Such a gas turbine set can advantageously also be operated with a sequential combustion where the detection according to the invention brings particularly great advantages when the problem of rubbing and/or contact points is at least twice as great, bearing in mind that a high-pressure and a low-pressure turbine are operatively active.

As an alternative, the machine for implementing the method according to the invention can also be designed as a steam turbine set which comprises at least one steam turbine and at least one generator.

### BRIEF DESCRIPTION OF THE DRAWINGS

Exemplary embodiments of the invention are explained below with the aid of the drawings. Any elements that are not essential for the direct understanding of the invention have been omitted. Identical elements are provided with the same reference numerals in the different drawings, in which:

FIG. 1 shows a cross section of a gas turbine set having a measurement system;

FIG. 2 shows a detailed cross section of a turbine, with the route of the pulse;

FIG. 3 shows a cross section of a gas turbine set with pulses fed in via the insulated bearing;

FIG. 4 shows a cross section of an insulated plain bearing;

FIG. 5 shows a cross section of a gas turbine set having two pulse and measurement coupling points;

FIG. 6 shows a cross section of a gas turbine set having three pulse and measurement coupling points and a sensor and measurement system; and

FIG. 7 shows a cross section of a gas turbine set having two pulse and measurement coupling points and a signal generator.

### DETAILED DESCRIPTION

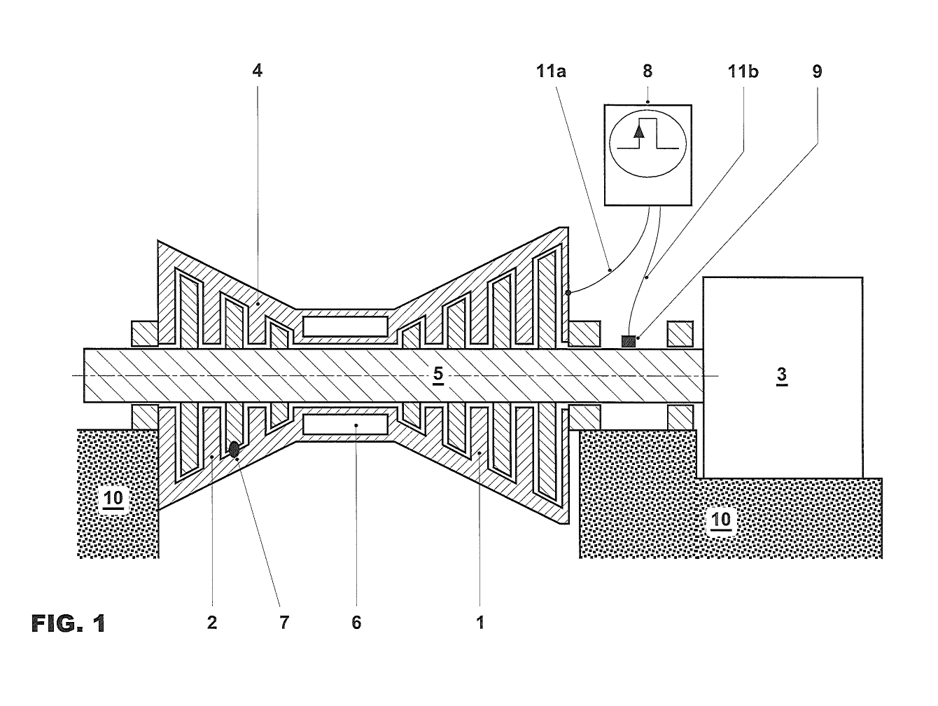

A gas turbine set that essentially consists of at least one compressor 1, one combustion chamber 6 that is only suggested in the drawing, one turbine 2, and one generator 3 is shown schematically in cross section in FIG. 1. Such a gas turbine set can also be operated by sequential combustion where a first turbine is arranged at the outlet side of a first combustion chamber connected downstream from the compressor, and a second combustion chamber is operated at the outlet side of this first turbine, the hot gases of which are applied to a second turbine. The rubbing point in the turbine is labeled as point 7 in the drawing. The measuring instrument 8 injects the said electrical voltage pulses into the coaxial system via measurement cables 11a, 11b, the contact on the housing 4, and the shaft contact 9 and uses them to measure the passage times or the transmission characteristics. The grounding contact that is always present is advantageously used as the shaft contact 9. The whole gas turbine set stands on a stable base 10.

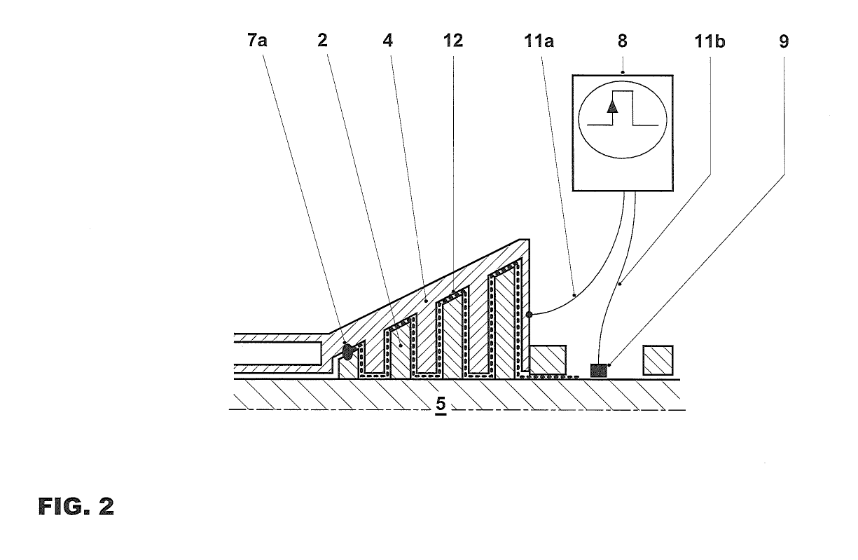

A turbine 2 is shown schematically in FIG. 2 as part of the gas turbine set with, shown in a dotted line, the possible route 12 of an electrical pulse that progresses through the non-metal gaps between the rotor 5 and the housing 4 and is reflected at the rubbing point 7a. In reality, there are multiple paths with multiple types of reflection determined partly by the rubbing point 7a itself and partly also by the components present, for example blades, that also act as points of discontinuity.

Appropriate algorithms for processing the measurement data make it possible to differentiate between normal, machine-specific reflections and actual rubbing points. For example, the pulse patterns are recorded during an operating state with no rubbing of the rotor and stored as reference patterns or reference data. It is then easier to detect reflections caused by rubbing points by comparison with this reference data.

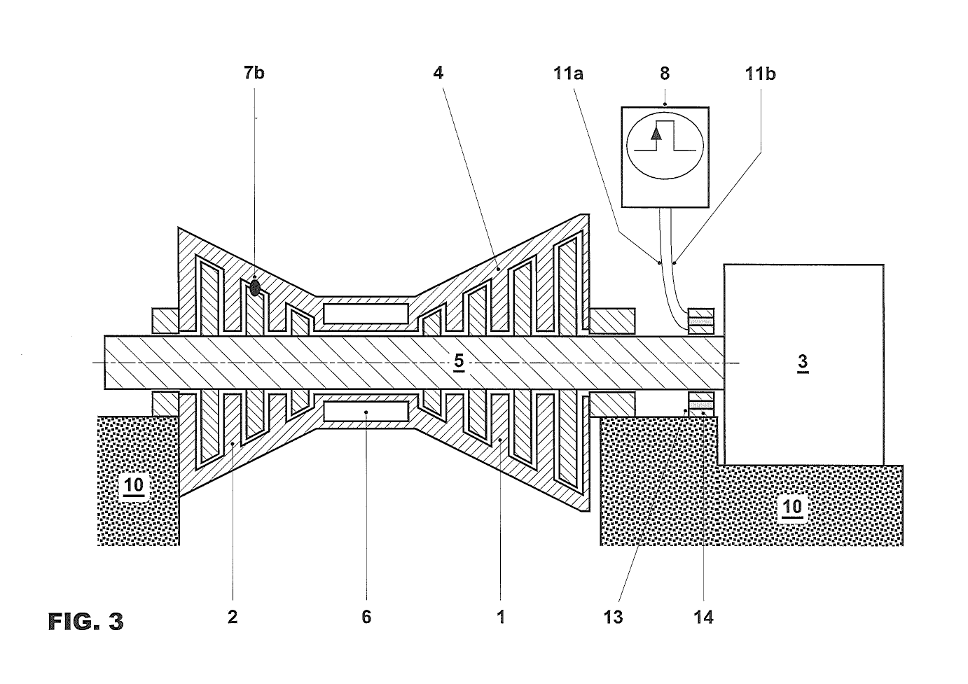

FIG. 3 shows a particularly advantageous feed-in point: the insulated generator bearing 13 is used to feed in pulses. At least the bearing on the non-driving side is insulated in all generators, and often the bearing on the driving side too. This means that the bearing shells 14 are arranged so that they are electrically insulated from the housing or from the ground. The bearing shells are, however, well coupled to the shaft in terms of high frequency via the thin films of lubricant. In order to feed in the measurement pulses 11a, 11b, voltage pulses are here applied between the bearing housing and the bearing shell. If a further insulated metal intermediate layer is arranged in the bearing, the measurement pulse can be applied between the housing and this additional layer. The pulses are then fed capacitively to the shaft.

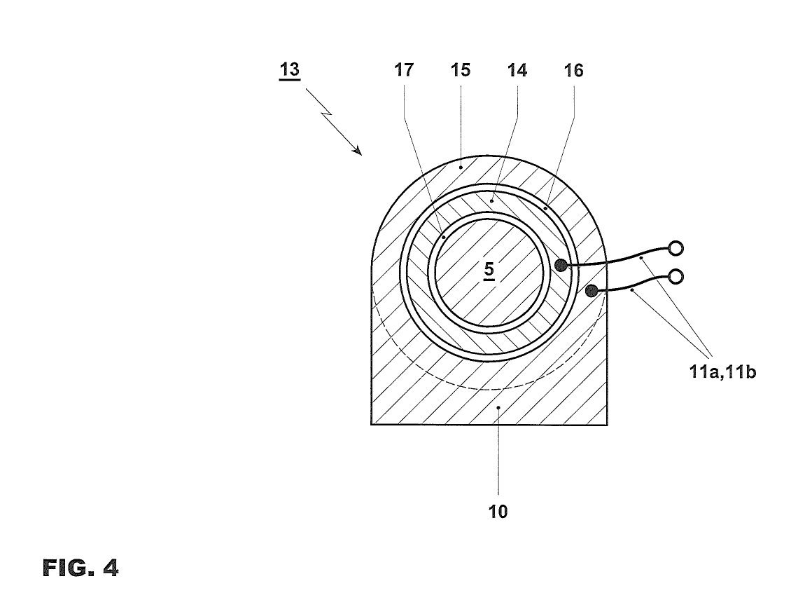

FIG. 4 shows an insulated generator bearing 13 that consists of an outer ring 15, an inner ring 14 consisting of bearing shells, an insulating layer 16 that acts between the outer ring 15 and the inner ring 14, a plain bearing supported on a film of oil 17 being provided between the inner ring 14 and the rotor shaft 5. The measurement pulses called on to detect rubbing points originate, on the one hand, from the inner ring 14 (11a) and, on the other hand, from the outer ring (11b), as can be seen specifically in FIG. 4.

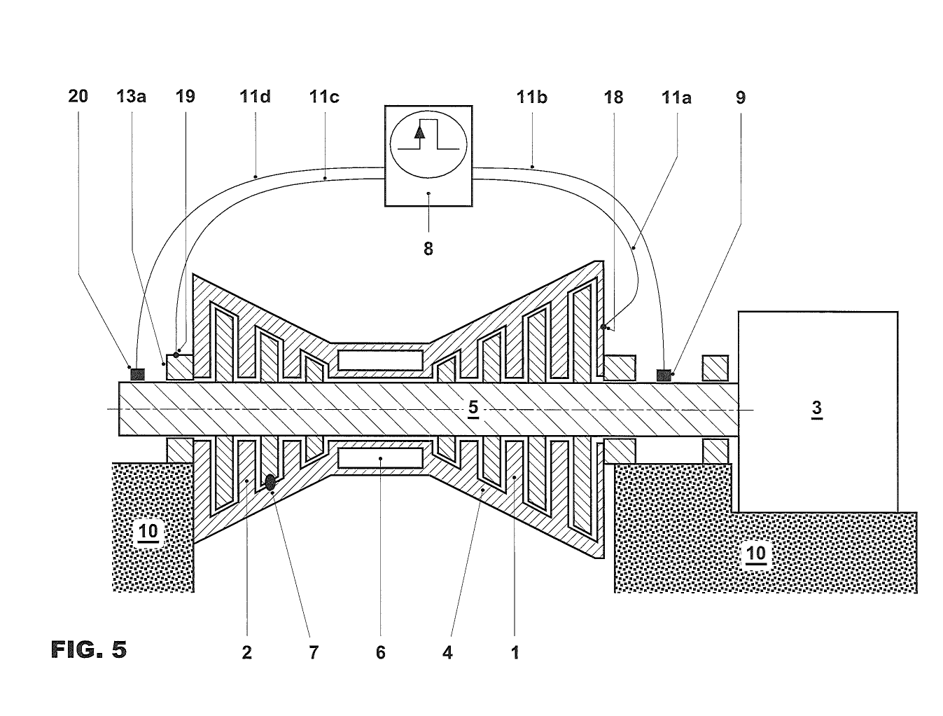

FIG. 5 shows a gas turbine set in which two pulse feed-in points, situated at separate locations, are shown. Firstly, a feed-in point 9 for the measurement pulses is situated on the compressor side on the rotor 5, and a second point 18 is situated on the housing of the compressor 4. Secondly, a feed-in point 18 for the measurement pulses is situated on the turbine side on the turbine bearing 13a, and a second point 20 is in turn situated on the rotor 5. In this arrangement, the pulses or measurement voltages are injected at one or both ends 19, 20 of the turbine and the system responses are measured at both locations. In this arrangement, for example dual-port transmission characteristics, for example the dual-port S-parameter matrix, can be identified. Improved location results can be obtained because of the different feed-in locations that cause different times for the pulse to pass to the rubbing point. In the most simple case, the two passage times must add up to a total passage time for the respective path through the turbine.

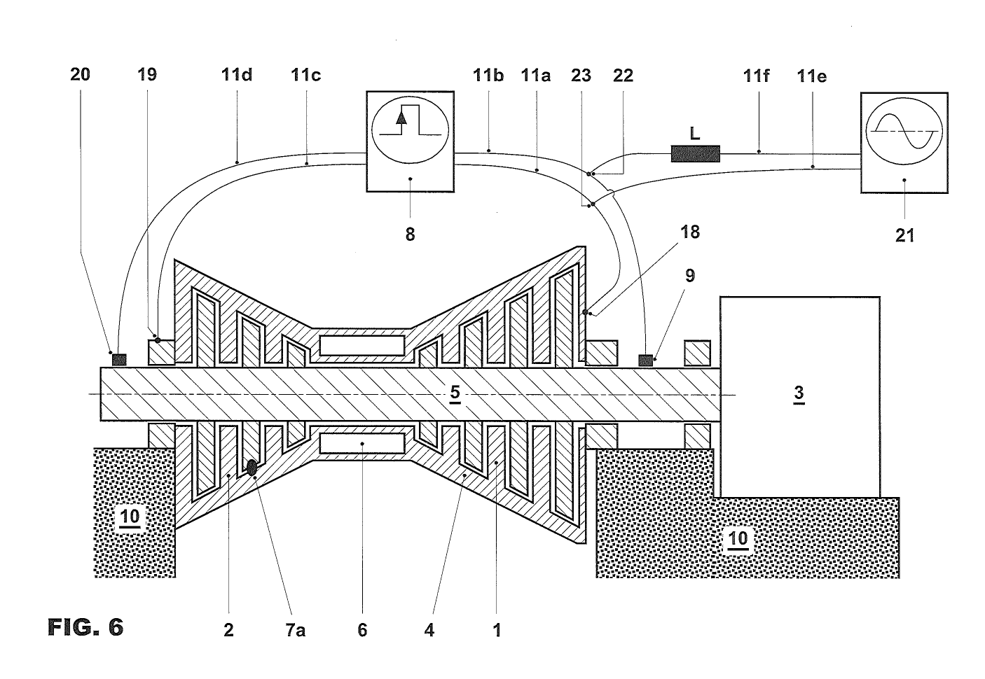

FIG. 6 shows in turn a gas turbine set having two pulse feed-in points which is largely based on the same structure as in FIG. 5. In this case according to FIG. 5, a capacitive air gap sensor L is used as the first emitter and receiver, and a shaft contact 9, typically the grounding contact of the shaft, is used as the second emitter. An EDMS system is additionally installed that is also used to detect rubbing points. The capacitive sensor of this EDMS system is inserted as a third sensor for the reflectometric rubbing point locating system. More reliable detection of rubbing phenomena can be obtained by correlating the measurement data with time when non-rubbing phenomena can be excluded.

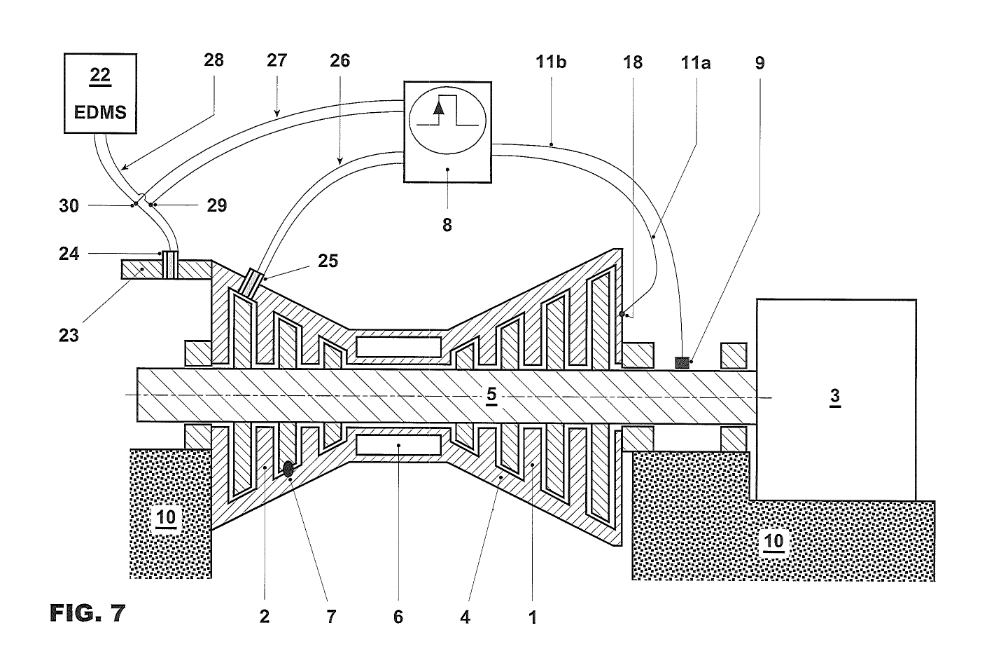

A gas turbine set can again be seen in FIG. 7. The measurement signals are fed in via two measurement points. A signal generator is additionally arranged at one measurement point such that the generated voltage is applied between the shaft and ground. The signal generator is coupled electrically via an electrical network that only allows low-frequency signals to pass from the shaft connection to the signal generator terminal.

In FIG. 7, this is simply a series inductance. The voltage generated by the signal generator is a relatively low-frequency alternating voltage, typically a sinusoidal voltage in the range +/−10V with a frequency of 1 Hz, for example. The rapid measurement pulses are overlaid on this slow alternating voltage. In the case of sufficiently small air gap widths in the region of, for example, the blades, the slow voltage causes an electrical flashover process when the breakdown field strength is reached. This flashover itself already generates high-frequency pulses that are received by the measurement device at both ends of the turbine and the differences in their passage times can be measured. The differences in passage time enable conclusions to be drawn about the location of the breakdown. The magnitude of the voltage applied at the breakdown enables conclusions to be drawn about the extent of the breakdown, i.e. the width of the smallest air gap in the system. The injected rapid pulses enable an additional location-finding because the plasma acts as a point of discontinuity in the region of the breakdown and the pulses are thus reflected. The short measurement pulses do not themselves cause an (avalanche) breakdown as they are too short for an avalanche to form. They can, however, certainly initiate a breakdown themselves that is then detected by the next pulse if this pulse follows at a short time gap.

What is claimed is:

1. A method for detecting rubbing and/or contact points on a machine with a rotating part, wherein the latter forms an electrical coaxial system together with the stationary part of the machine:
said method comprising propagating electrical voltage signals between the rotating and the stationary part at passage times, applying short electrical voltage pulses and/or continuous alternating voltage signals at least one location of the machine between the rotating part and the stationary part at a suitable point, wherein a point of electrical discontinuity in the path of propagation being active between the rotating and the stationary part at a rubbing and/or contact point, and performing passage time measurements in order to locate this rubbing and/or contact point.

2. The method as claimed in claim 1, wherein all the rotating parts of the machine are carried by a single continuous rotor, and in that the stationary part is formed by a stator.

3. The method as claimed in claim 1, further comprising locating the rubbing and/or the contact points in the machine using reflectometric measurement methods.

4. The method as claimed in claim 1, further comprising injecting short electromagnetic pulses into the machine, specifically into the cavity between the rotor and the stator, for the reflective measurement.

5. The method as claimed in claim 1, further comprising applying a slowly changing voltage to the rotor with respect to the stator in order to generate the voltage pulses, selecting the amplitude of said voltage to be of such a magnitude that electrical breakdowns between the rotor and stator occur at the rubbing points, and locating electrical breakdowns which occur at the rubbing points by passage time measurements and/or on the basis of the pulse patterns forced by the machine geometry.

6. The method as claimed in claim 1, further comprising feeding the voltage pulses and/or the continuous alternating voltage signals via the grounding contacts of the rotor.

7. The method as claimed in claim 1, further comprising feeding the voltage pulses and/or the continuous alternating voltage signals via a bearing on the driving side or non-driving side of a generator belonging to the machine.

8. The method as claimed in claim 1, further comprising feeding the voltage pulses and/or the continuous alternating voltage signals at both ends of the machine, or at least at a turbine belonging to the machine, or at least at a compressor belonging to the machine.

9. The method as claimed in claim 1, further comprising feeding the voltage pulses and/or the continuous alternating voltage signals the reflected pulses are measured and/or the rubbing and/or contact points are located via at least one EDMS sensor and/or at least one blade tip distance sensor belonging to the turbine.

10. The method as claimed in claim 5, further comprising additionally overlaying the applied, slowly changing voltage with rapid voltage pulses.

11. The method as claimed in claim 1, further comprising simultaneously processing reference data from a machine with no points of discontinuity for calculating by measurement the rubbing and/or contact points, and/or reference data from a machine with points of discontinuity that have been located are simultaneously used.

12. The method as claimed in claim 10, further comprising applying static methods based on the rotational phases are applied to calculate the points of discontinuity.

13. The method as claimed in claim 1, further comprising validating a pulse coding is carried out to maximize the identification of pulse echoes for measurement purposes when the pulses are emitted, which pulse coding contains a pulse sequence with known, short, identical or different pulse intervals and/or an appropriate gradation of the pulse amplitudes.

14. The method as claimed in claim 12, further comprising using radar location methods to detect the pulse echoes.

15. A machine for carrying out the method as claimed in claim 1, wherein the machine is a gas turbine set that essentially consists of at least one compressor, at least one combustion chamber, at least one turbine, at least one generator, and at least one rotor, and the rotor is operatively connected to a stator.

16. The machine as claimed in claim 15, wherein the gas turbine set has a sequential combustion, wherein the first turbine is arranged at the outlet side of a first combustion chamber connected downstream from the compressor, and the second turbine is arranged at the outlet side of a second combustion chamber.

17. A machine for carrying out the method as claimed in claim 1, wherein the machine is a steam turbine set that comprises at least one generator and one steam turbine.
